(19) United States
(12) Patent Application Publication
(10) Pub. No.: US 2016/0277454 A1
(43) Pub. Date: Sep. 22, 2016

(54) IMAGE SHARING APPARATUS, IMAGE SHARING SYSTEM, AND GRAPHICAL USER INTERFACE

(71) Applicant: Satoru Sugishita, Kanagawa (JP)

(72) Inventor: Satoru Sugishita, Kanagawa (JP)

(73) Assignee: Ricoh Company, Ltd., Tokyo (JP)

(21) Appl. No.: 15/069,415

(22) Filed: Mar. 14, 2016

(30) Foreign Application Priority Data
Mar. 19, 2015 (JP) 2015056818

(51) Int. Cl. H04L 29/06; G06F 3/0481; G06T 1/00

(52) U.S. Cl. CPC H04L 65/1093; G06T 1/0007; G06F 3/0481; H04L 65/1089; H04L 65/4038; G06T 2200/24

(57) ABSTRACT

An image sharing apparatus is provided. The image sharing apparatus includes a first management unit configured to provide participation permission to one or more other image sharing apparatuses connected to the image sharing apparatus via a first network, and to control the image sharing apparatuses to which the participation permission has been provided; a second management unit configured to, when a participation request is received from one or more information terminals connected the image sharing apparatus via a second network, different from the first network, provide the participation permission to the information terminals, and to control the information terminals to which the participation permission has been provided; and a transfer unit configured to transfer image data to the other image sharing apparatuses controlled by the first management unit and the information terminals controlled by the second management unit.

### CROSS-REFERENCE TO RELATED APPLICATION

The present application is based on and claims the benefit of priority of Japanese Priority Application No. 2015-056818 filed on Mar. 19, 2015, the entire contents of which are hereby incorporated herein by reference.

### BACKGROUND OF THE INVENTION

1. Field of the Invention

The present invention relates to an image sharing apparatus, an image sharing system, and a graphical user interface.

2. Description of the Related Art

There is a system in which, for example, a plurality of personal computers are connected to each other via a network, and data is shared among members of a group included in the network.

In this kind of a system, a method is known in which a list of conference members is displayed, and a conference owner selects conference members to be invited (refer to, for example, Patent Document 1).

However, in the method of Patent Document 1, the conference owner has to acknowledge the conference members (participants) before selecting the members, and thus, it takes time to hold a conference, which is not convenient. On the other hand, for example, in the case of a conference where confidential information is included, the conference is not safe in terms of security if participants of the conference are not limited.

One aspect of the present invention improves security efficiently.

### CITATION LIST

### Patent Document

[Patent Document 1] Japanese Laid-Open Patent Application No. 2006-303742

### SUMMARY OF THE INVENTION

An image sharing apparatus according to an embodiment of the present invention includes a first management unit configured to provide participation permission to one or more other image sharing apparatuses connected to the image sharing apparatus via a first network, and control the image sharing apparatuses to which the participation permission has been provided, a second management unit configured to, in the case where a participation request is received from one or more information terminals connected the image sharing apparatus via a second network different from the first network, provide the participation permission to the information terminals, and control the information terminals to which the participation permission has been provided, and a transfer unit configured to transfer image data to the other image sharing apparatuses controlled by the first management unit and the information terminals controlled by the second management unit.

Other objects, features and advantages of the present invention will become more apparent from the following detailed description when read in conjunction with the accompanying drawings.

According to an embodiment of the present invention, it is possible to improve security efficiently.

### BRIEF DESCRIPTION OF THE DRAWINGS

FIG. 1 is a drawing illustrating an example of a schematic configuration of an image sharing system according to an embodiment.

FIG. 2 is a drawing illustrating an example of a hardware configuration of a computer system.

FIG. 3 is a drawing illustrating an example of a functional configuration of an image sharing system according to an embodiment.

FIG. 4 is a sequence diagram illustrating an example of an image sharing process according to an embodiment.

FIG. 5 is a drawing illustrating an example of a list of image sharing apparatuses according to an embodiment.

FIG. 6 is a drawing illustrating an example of a list of participants according to an embodiment.

FIG. 7 is a drawing illustrating an example of a screen of an image sharing apparatus used as a conference owner.

FIG. 8 is a drawing illustrating an example of a screen of another image sharing apparatus used by a conference participant.

FIG. 9 is a sequence diagram illustrating an example of an image sharing process by another image sharing apparatus.

FIG. 10 is a drawing illustrating an example of switching an image sharing screen.

### DETAILED DESCRIPTION OF THE PREFERRED EMBODIMENTS

In the following, embodiments of the present invention will be described in detail.

<Image Sharing System: Schematic Configuration>

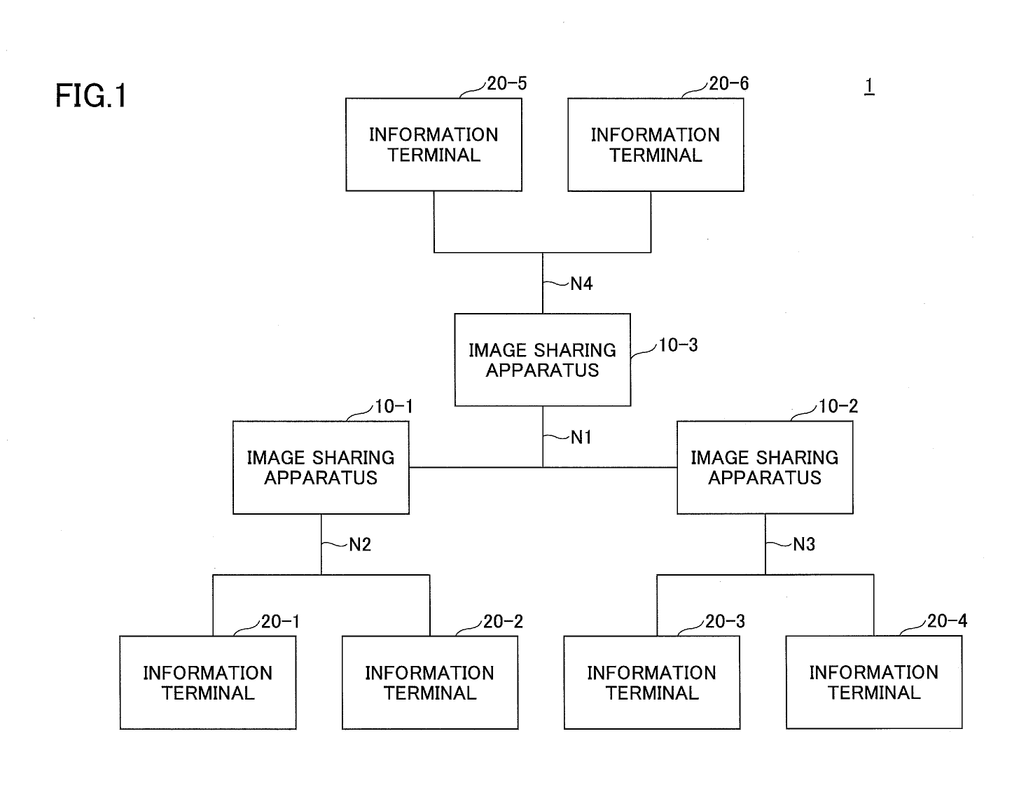

FIG. 1 is a drawing illustrating an example of a schematic configuration of an image sharing system 1 according to an embodiment. The image sharing system 1 in FIG. 1 includes, for example, image sharing apparatuses 10-1 through 10-3 (arbitrarily referred to as “image sharing apparatus 10”) and information terminals 20-1 through 20-6 (arbitrarily referred to as “information terminal 20”). In an example of FIG. 1, the image sharing system 1 realizes a conference with a remote location by, for example, sharing an image used for the conference.

In the example of FIG. 1, the image sharing apparatuses 10-1 through 10-3 are connected to each other via a network N1 (an example of a first network) such as the Internet, a Local Area Network (LAN), or the like, and transmit/receive a sharing image to/from each other. The image sharing apparatus 10-1 and the information terminals 20-1 and 20-2 are connected to each other via a wireless network N2 (an example of a second network), and a shared image is transmitted/received via the image sharing apparatus 10-1. The image sharing apparatus 10-2 and the information terminals 20-3 and 20-4 are connected to each other via a wireless network N3 (an example of a third network), and a shared image is transmitted/received via the image sharing apparatus 10-2. The image sharing apparatus 10-3 and the information terminals 20-5 and 20-6 are connected to each other via a wireless network N4 (an example of a fourth network), and a shared image is transmitted/received via the image sharing apparatus 10-3.

When start of a conference is specified by a user, the image sharing apparatus 10 is used as a conference owner, and instructs other image sharing apparatuses 10 to start sharing an image. It should be noted that the user specifies the start of a conference by, for example, but not limited to, directly operating the image sharing apparatus 10. The image sharing apparatus 10 used as a conference owner provides other image sharing apparatuses 10 with permission for participating in the conference. Further, authority to provide information terminals 20 with permission for participating in the conference is transferred to the other image sharing apparatuses 10 to which permission for participating in the conference has been provided

In the example of FIG. 1, it is assumed that the image sharing apparatus 10-1, which is used to specify the start of a conference by the user, is used as a conference owner, and authority to provide information terminals 20 with permission for participating in the conference is transferred to the image sharing apparatuses 10-2 and 10-3.

The image sharing apparatus 10 is, for example, but not limited to, a PC, a server, etc. The image sharing apparatus 10 may be, for example, an interactive whiteboard (IWB), an electronic whiteboard, a projector, or the like.

The information terminal 20 is, for example, a PC, and is operated by a conference participant. It should be noted that the information terminal 20 may be a mobile terminal such as a smartphone, a tablet terminal, or the like. It is possible for an information terminal 20 to participate in the conference when it is in such a range that radio waves from the information terminal 20 reaches the image sharing apparatus 10.

In the example of FIG. 1, the image sharing apparatus 10-1 provides permission to participate in the conference to the information terminals 20-1 and 20-2, whose conference participation requests have been received via the wireless network N2. The image sharing apparatus 10-2 provides permission to participate in the conference to the information terminals 20-3 and 20-4, whose conference participation requests have been received via the wireless network N3. The image sharing apparatus 10-3 provides permission to participate in the conference to the information terminals 20-5 and 20-6, whose conference participation requests have been received via the wireless network N4.

The above-described image sharing apparatus 10 receives a participation request from, for example, an information terminal 20 within a range of radio waves reach. As a result, an information terminal 20 in the same meeting room as the image sharing apparatus 10 can participate in the conference. Similarly, other image sharing apparatuses 10 to which the authority is transferred also provide permission to participate to an information terminal 20, which is in the range where the information terminal 20 can be seen and acknowledged by the image sharing apparatus 10. As a result, participants of the conference can be safely controlled.

<Hardware Configuration>

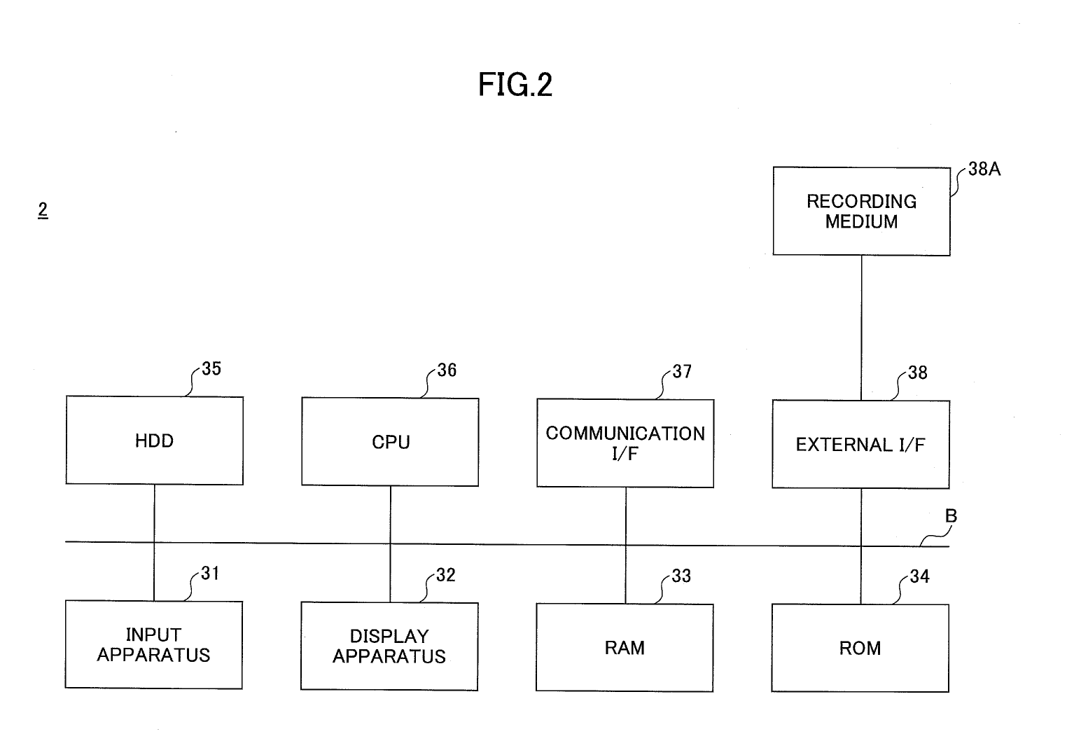

The above-described image sharing apparatus 10 and the information terminal 20 are realized by, for example, a computer system with a hardware configuration as shown in FIG. 2. FIG. 2 is a drawing illustrating an example of a hardware configuration of a computer system 2.

The computer system 2 shown in FIG. 2 includes an input apparatus 31, a display apparatus 32, a random access memory (RAM) 33, a read only memory (ROM) 34, a hard disk drive (HDD) 35, a central processing unit (CPU) 36, a communication interface (I/F) 37, and an external interface (I/F) 38, which are connected to each other via a bus B.

The input device 31 includes a keyboard, a mouse, a touch panel, and the like, and is used by a user to input operation signals. The display device 32 includes a display and the like, and displays a result of a process by the computer system 2. The display apparatus 32 may be an interactive whiteboard, an electronic whiteboard, a projector, a large-scale screen, etc.

The RAM 33 is a volatile semiconductor memory (storage device) that is capable of temporarily holding a program or data. The ROM 34 is a non-volatile semiconductor memory (storage device) that is capable of holding a program or data even when the power supply is turned off. The ROM 34 stores programs and data including a basic input/output system (BIOS) that is executed at a start-up of the computer system 2, operating system (OS) settings, network settings, or the like.

The HDD 35 is a non-volatile storage device in which a program and data are stored. The stored programs and data include, for example, an OS which is basic software controlling the entire computer system 2 and application software which provides various functions on the OS.

The HDD 35 stores the programs and data by using a predefined file system and/or a database (DB). It should be noted that the computer system 2 may include a solid state drive (SSD) in place of the HDD 35.

The CPU 36 is an arithmetic device which realizes control and functions of the entire computer system 2 by reading programs and data from a storage device such as the ROM 34 and the HDD 35, writing the read programs and data to the RAM 33, and performing processes.

The communication I/F 37 is an interface for connecting the computer system 2 to a network N. The computer system 2 performs data communication via the communication I/F 37.

The external I/F 38 is an interface with an external apparatus. The external apparatus includes a recording medium 38A, or the like. The computer system 2 is capable of reading from and/or writing to the recording medium 38A via the external I/F 38.

The recording medium 38A includes a flexible disk, a compact disk (CD), a digital versatile disk (DVD), an SD memory card, a universal serial bus (USB) memory, etc.

The image sharing apparatus and the information terminal 20 are capable of performing various processes described below by having a hardware configuration of the computer system 2.

<Functional Configuration of Image Sharing Apparatus 10>

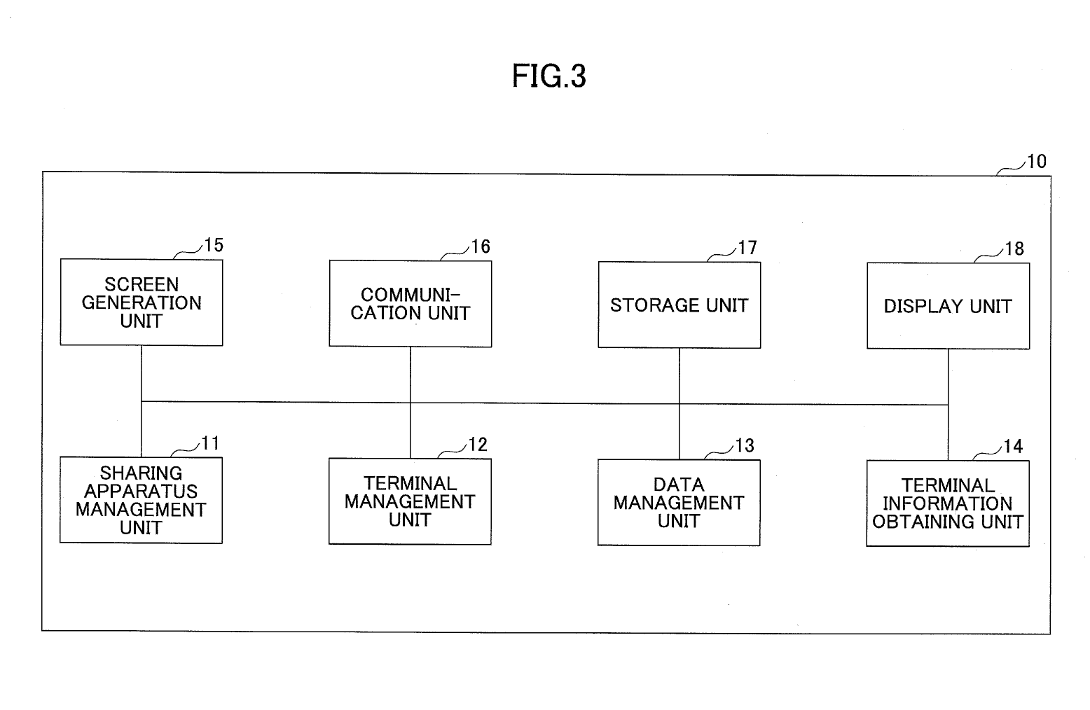

FIG. 3 is a drawing illustrating an example of a functional configuration of an image sharing apparatus 10 according to an embodiment. As shown in FIG. 3, the image sharing apparatus 10 includes a sharing apparatus management unit (first management unit) 11, a terminal management unit (second management unit) 12, a data management unit 13, terminal information obtaining unit 14, a screen generation unit 15, a communication unit (transfer unit) 16, a storage unit 17, and a display unit 18.

When, for example, the image sharing apparatus 10 is used as a conference owner, the sharing apparatus management unit 11 controls list information (image sharing apparatus list) of image sharing apparatuses 10 generated by, for example, a right-after-start-up search or a regular search of the network N1. Further, the sharing apparatus management unit 11 controls image sharing apparatuses 10 of the image sharing apparatus list to which apparatuses the image sharing apparatus 10 has provided permission for image sharing participation (conference participation).

It should be noted that the sharing apparatus management unit 11 may be omitted from the image sharing apparatus 10 in the case where, for example, it is not used as a conference owner but used as a conference participant.

The terminal management unit 12 controls list information (participant list) of the information terminals 20 from which a request for image sharing participation (conference participation) has been received. Further, the terminal management unit 12 controls information terminals 20 of the participant list to which terminals the image sharing apparatus 10 has provided permission for image sharing participation. Further, the terminal management unit 12 obtains information related to the information terminals 20 to which the image sharing apparatus 10 has provided permission for image sharing participation via other image sharing apparatuses 10 by using the terminal information obtaining unit 14. The terminal management unit 12 updates the participant list with the information terminal 20 to which the image sharing apparatus 10 has provided permission for image sharing participation.

By using the sharing apparatus management unit 11 and the terminal management unit 12, the image sharing apparatus 10 used as a conference owner can obtain information on which participant participates in a conference via which image sharing apparatus 10 (including the image sharing apparatus 10 used as a conference owner itself).

The data management unit 13 controls sharing image data for which image sharing request has been received from another image sharing apparatuses 10 and an information terminal 20. The request for image sharing is transmitted to the image sharing apparatus 10 used as a conference owner in the case where, for example, a participant who operates another image sharing apparatus 10 or an information terminal 20 wants to share data such as predetermined information (e.g., conference materials or reference materials).

The terminal information obtaining unit 14 receives from another image sharing apparatus 10 information on an information terminal 20 to which image sharing participation permission has been provided.

The screen generation unit 15 generates a screen displayed on the display unit 18 in the case where the image sharing apparatus 10 is used as a conference owner; a screen displayed on the display unit 18 in the case where the image sharing apparatus 10 is used as other than a conference owner; and a graphical user interface such as a screen displayed by an information terminal 20. It should be noted that the screen generated by the screen generation unit 15 is not limited to the above-described screens, but may include, for example, a start screen or a termination screen of an image sharing system, a screen at the time of error occurrence, etc.

Further, in the case where the image sharing apparatus 10 is used as a conference owner, the screen generation unit 15 may generate a screen in which one or more data (conference materials, etc.,) obtained via an image sharing apparatus 10 or an information terminal 20 currently participating in the conference can be switched and displayed. The screen generation unit 15 may display data, for example, obtained from an information terminal 20 selected from the information related to the information terminals 20 (participant information) displayed on the screen. It should be noted that a graphical user interface generated by the screen generation unit 15 may be displayed on a screen of another image sharing apparatus 10 or an information terminal 20 via the communication unit 16.

The communication unit 16 transmits and receives data to and from another image sharing apparatus 10 or an information terminal 20.

The storage unit 17 stores an image sharing apparatus list controlled by the sharing apparatus management unit 11, a participant list controlled by the terminal management unit 12, sharing image data controlled by the data management unit 13, etc. It should be noted that the information stored in the storage unit 17 is not limited to the above, but may include, for example, user information, an execution log, or the like.

The display unit 18 outputs a screen (graphical user interface) generated by the screen generation unit 15. Further, the display unit 18 may be a touch panel, etc. When an information item displayed on the screen is touched, the touched information item is selected and corresponding process may be performed.

<Flowchart of Image Sharing Process>

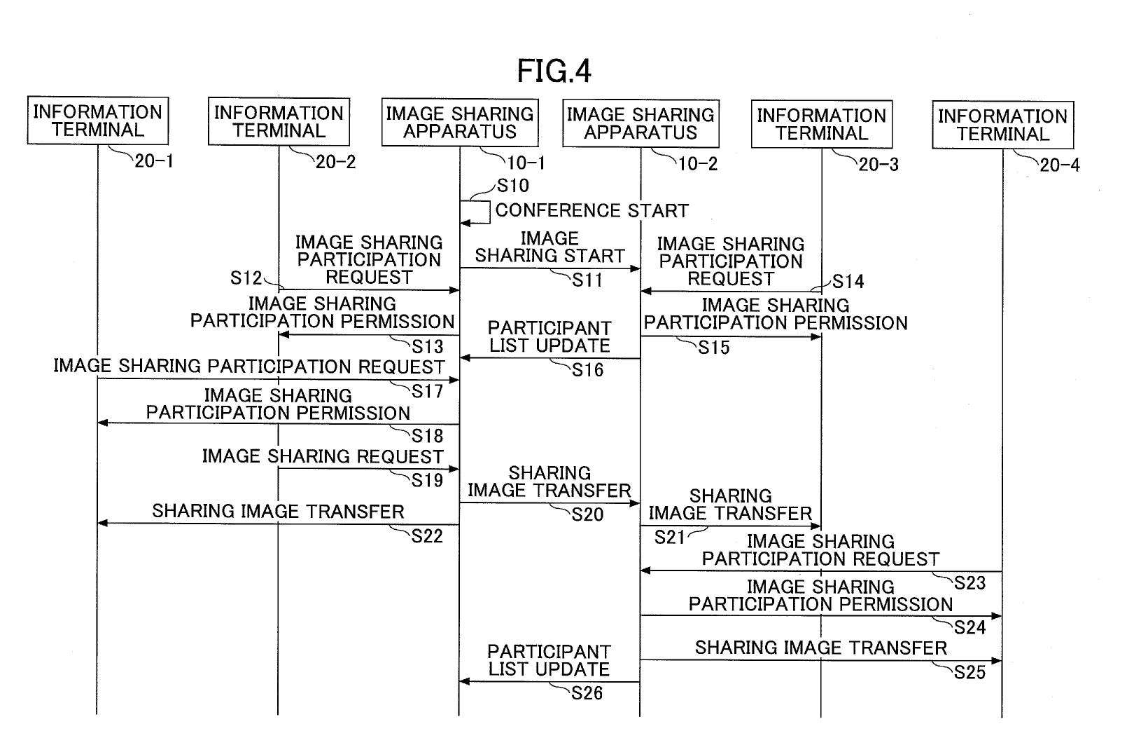

FIG. 4 is a sequence diagram illustrating an example of an image sharing process according to an embodiment. The sequence shown in FIG. 4 is performed by the image sharing apparatuses 10-1 and 10-2, the information terminals 20-1 through 20-4.

As shown in FIG. 4, the image sharing apparatus 10-1 is used as a conference owner when, for example, the image sharing apparatus 10-1 receives an instruction of conference start from a user (S10). The image sharing apparatus 10-1, used as a conference owner, instructs the image sharing apparatus 10-2 to start image sharing (S11).

It should be noted that the image sharing apparatus 10-1, used as a conference owner, may set another image sharing apparatus 10 (e.g., the image sharing apparatus 10-2) as a conference participant in advance, or may select the image sharing apparatus 10-2 from the image sharing apparatus list at the time of conference start. The image sharing apparatus list may be automatically generated by using information of connected image sharing apparatuses 10 obtained by a right-after-start-up search or a regular search of the network N1.

To a user (participant) who uses another image sharing apparatus 10 (e.g., image sharing apparatus 10-2), permission to participate in a conference is provided by the image sharing apparatus 10-1 used as a conference owner, and authority to provide permission for participating in the conference to an information terminal 20 that wants to participate in the conference is transferred. As a result, it is possible for the other image sharing apparatus 10 (e.g., image sharing apparatus 10-2) to provide permission to participate in the conference only to the information terminal 20 that can be checked by the user.

Next, when a request for conference participation (image sharing participation) is received from the information terminal 20-2 (S12), the image sharing apparatus 10-1 used as a conference owner provides permission for image sharing participation (S13). As a result, it becomes possible for the information terminal 20-2 to share an image with the image sharing apparatus 10-1. It should be noted that it is possible for the image sharing apparatus 10-1 to reject the request for image sharing participation in process S13. In this case, the information terminal 20-2 cannot participate in the conference. Further, when a request for image sharing participation is received from the information terminal 20-3 (S14), the image sharing apparatus 10-2 provides permission for image sharing participation (S15).

As shown in processes S12 through S15, it is possible for the image sharing apparatus 10 (e.g., image sharing apparatus 10-1) used as a conference owner and the other image sharing apparatus 10 (e.g., image sharing apparatus 10-2) to which the authority has been transferred to provide an information terminal 20 with permission for participating in the conference.

After providing the information terminal 20-3 with permission for image sharing participation, the image sharing apparatus 10-2 transmits an update of the participation list to the image sharing apparatus 10-1 used as a conference owner (S16). It should be noted that when transmitting the update of the participant list, the image sharing apparatus 10-2 may transmit, for example, a user name based on account information of the information terminal 20 or identification information of the information terminal 20. Further, when a request for conference participation is received from the information terminal 20-1 (S17), the image sharing apparatus 10-1 provides permission for image sharing participation (S18).

Next, when a request for image sharing is received from the information terminal 20-2 (S19), the image sharing apparatus 10-1 transfers sharing image data (sharing image) for which the request for image sharing has been received to the image sharing apparatus 10-2 (S20). The image sharing apparatus 10-2 transfers the sharing image data to the information terminal 20-3 (S21). The image sharing apparatus 10-1 transfers the sharing image data to the information terminal 20-1. As described above, the image sharing apparatuses 10-1 and 10-2 transfers the sharing image data to corresponding information terminals 20 which are registered in and controlled by the image sharing apparatuses 10-1 and 10-2.

When a new request for image sharing participation is received from the information terminal 20-4 (S23), the image sharing apparatus 10-2 provides permission for image sharing participation (S24) and transfers sharing image data to the information terminal 20-4 (S25). Further, the image sharing apparatus 10-2 transmits an update of the participant list to the image sharing apparatus 10-1, used as a conference owner (S26).

As described above, the image sharing apparatus 10 used as a conference owner, not only provides permission for participating in the conference to another image sharing apparatus 10, but also transfers authority to provide participation permission responding to a participation request from an information terminal 20. With the above operation, it becomes possible to distribute the effort of the image sharing apparatus 10 used as a conference owner of determining participation permission for all the information terminals 20 because each of the image sharing apparatuses 10 provide permission for participating in the conference to the corresponding information terminals 20, and thus, it becomes possible to hold a conference safely and efficiently.

<Image Sharing Apparatus List>

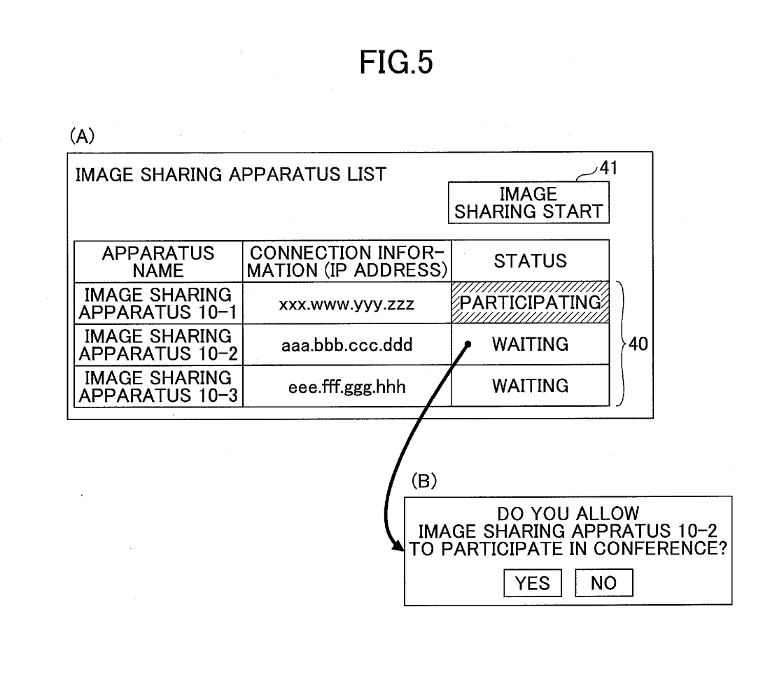

FIG. 5 is a drawing illustrating an example of an image sharing apparatus list according to an embodiment. An image sharing apparatus list screen (A) in FIG. 5 is generated, for example, by the screen generation unit 15 of the image sharing apparatus 10 used as a conference owner at a conference start timing, and is displayed by the display unit 18. In the image sharing apparatus list screen (A), “apparatus name”, “connection information (IP address)”, “status (state of usage)”, etc., are shown as list information of the image sharing apparatuses (image sharing apparatus list).

As an item of “status” shown in the image sharing apparatus list screen (A), “participating” is shown for the image sharing apparatus 10-1 which is participating in the conference. Here, when a status item 40 corresponding to an image sharing apparatus 10-2 is selected, a participation selection screen (B) is displayed. It is possible to allow an image sharing apparatus 10-2 to participate in the conference by using the participation selection screen (B).

Further, in the image sharing apparatus list screen (A), it is possible to select multiple image sharing apparatuses 10, select “image sharing start” 41, and allow all of the selected image sharing apparatuses 10 to participate in the conference at a time.

<Participant List>

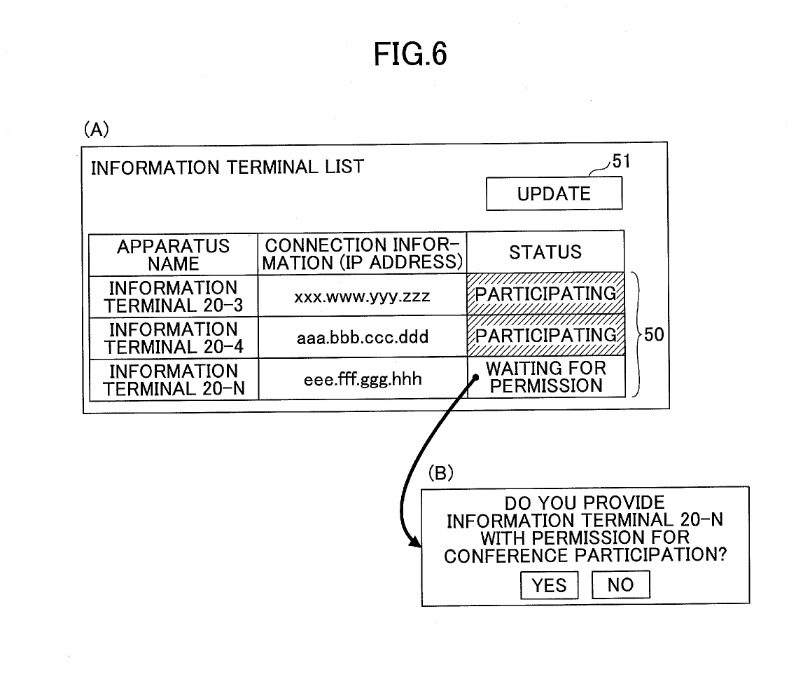

FIG. 6 is a drawing illustrating an example of a participant list according to an embodiment. A participant list screen (A) in FIG. 6 is generated by the screen generation unit 15 of the image sharing apparatus 10 used as a conference owner and the image sharing apparatus 10 participating in the conference (sharing image), and displayed by the display unit 18. In the participant list screen (A), “apparatus name”, “connection information (IP address)”, “status (state of usage)”, etc., are shown as list information of the information terminals 20 (participant list).

When a status item 50 corresponding to an information terminal 20-N is selected, a participation selection screen (B) is displayed. It is possible to allow an information terminal 20-N to participate in the conference by using the participation selection screen (B).

Further, when “update” 51 is selected in the participant list screen (A), information of the participant list shown in the participant list screen (A) is updated.

<Screen Example of Conference Owner>

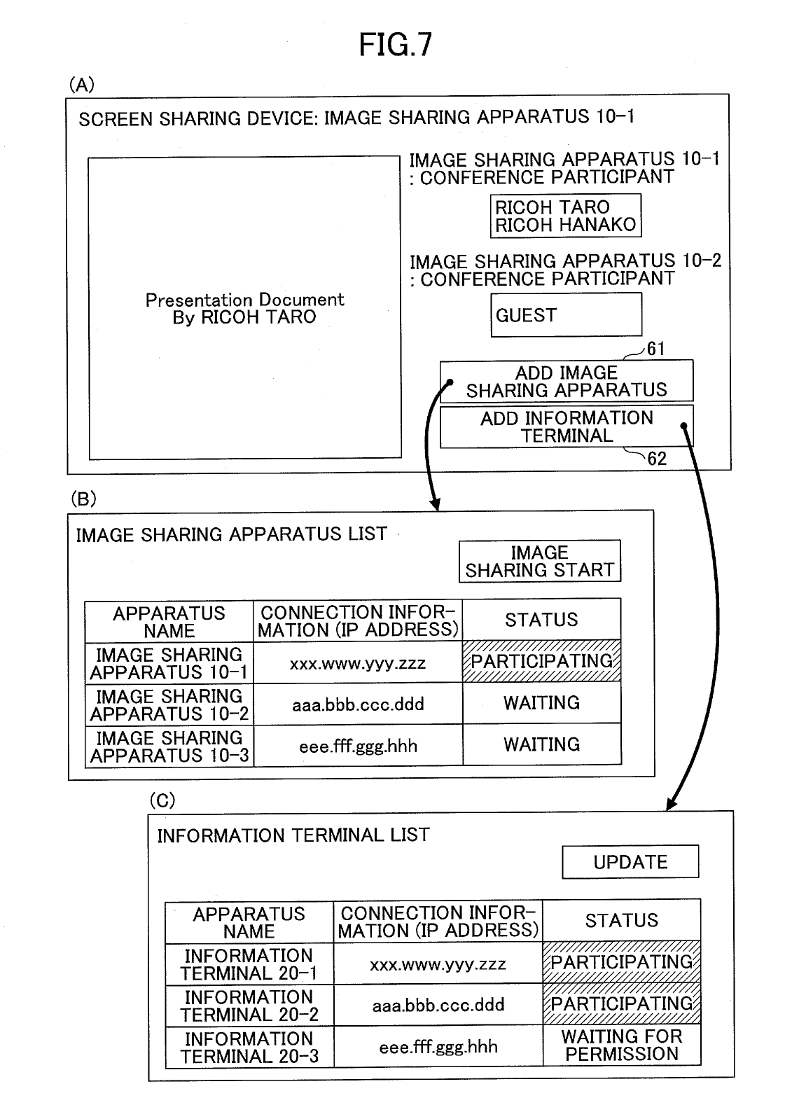

Next, screen examples of the image sharing apparatus 10 used as a conference owner will be described referring to the drawings. FIG. 7 is a drawing illustrating screen examples of an image sharing apparatus used by a conference owner. A screen (A) in FIG. 7 is generated by the screen generation unit 15 of the image sharing apparatus 10 used as a conference owner at a timing of image sharing start, and is displayed by the image sharing apparatus 10.

In the screen (A), an apparatus name of the image sharing apparatus 10, whose data are currently displayed, and the data (sharing image data, etc.,) are displayed. Further, in the screen (A), a list of the image sharing apparatuses 10 currently performing image sharing, participant information of the information terminals 20 (to which participation permission has been provided) currently performing image sharing by using corresponding image sharing apparatuses 10, etc., are shown. The participant information of the information terminals 20 is account (login) information obtained when the information terminal 20 has first communicated with the image sharing apparatus 10, or the like. It should be noted that the content shown in the screen, layout, etc., are not limited to the above.

When “add image sharing apparatus” 61 shown in the screen (A) of FIG. 7 is selected, a screen (B) including a list of image sharing apparatuses capable of participating in the conference (refer to the screen (A) of FIG. 5) is displayed. Further, when “add information terminal” 62 shown in the screen (A) of FIG. 7 is selected, a screen (C) including a list of participants capable of participating in the conference (refer to the screen (A) of FIG. 6) is displayed. By having the above screens displayed, it becomes possible to allow the image sharing apparatuses 10 and the information terminals 20 to participate in the conference.

<Screen Example of Another Image Sharing Apparatus 10 Participating in the Conference>

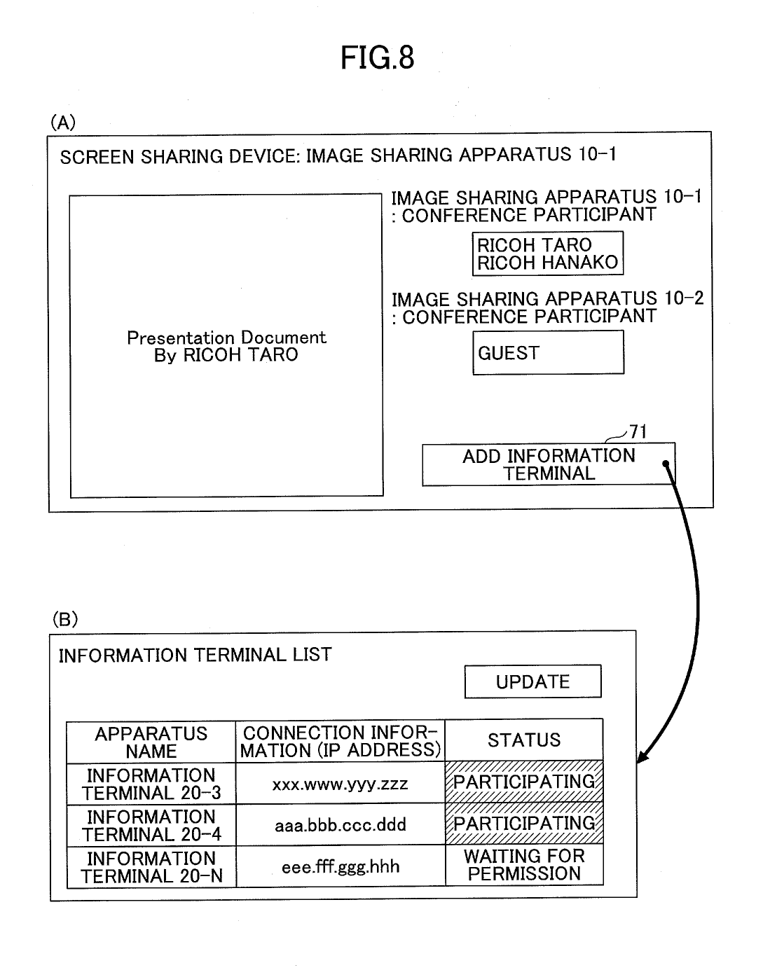

FIG. 8 is a drawing illustrating screen examples of another image sharing apparatus used by a conference participant. A screen (A) of FIG. 8 is generated by the image generation unit 15 of the image sharing apparatus 10 (e.g., image sharing apparatus 10-1) used as a conference owner at a timing of image sharing start, and transferred to another image sharing apparatus 10 (e.g., image sharing apparatus 10-2) participating in the conference other than the conference owner. Further, it is possible for the image sharing apparatuses 10 to transfer the screen (A) of FIG. 8 to the corresponding information terminals 20 performing image sharing by using the image sharing apparatuses 10.

When the screen (A) of FIG. 8 is compared with the screen (A) of FIG. 7, “add image sharing apparatus” 61 shown in the screen (A) of FIG. 7 is shown only in the screen (A) of FIG. 7. As described above, “add image sharing apparatus” 61 is shown only in the screen of the image sharing apparatus 10 used as a conference owner, and is not shown in the screen of the image sharing apparatus 10 used as other than the conference owner.

With the above arrangement, in the present embodiment, it is possible only for the image sharing apparatus 10 used as a conference owner to add another image sharing apparatus 10 to participate in the conference, and thus, it is possible to perform appropriate member management, material information management, or the like.

Further, when “add information terminal” 71 shown in the screen (A) of FIG. 8 is selected, a screen (B) of FIG. 8 including a list of participants capable of participating in the conference (refer to the screen (A) of FIG. 6) is displayed. With the above arrangement, it is possible to allow participation of the information terminals 20.

As described above, the image sharing apparatus 10 and the information terminal 20 participating in the conference can share a screen in which the name of the apparatus (whose data are currently displayed), the data, etc., are shown.

<Image Sharing Process by Another Image Sharing Apparatus>

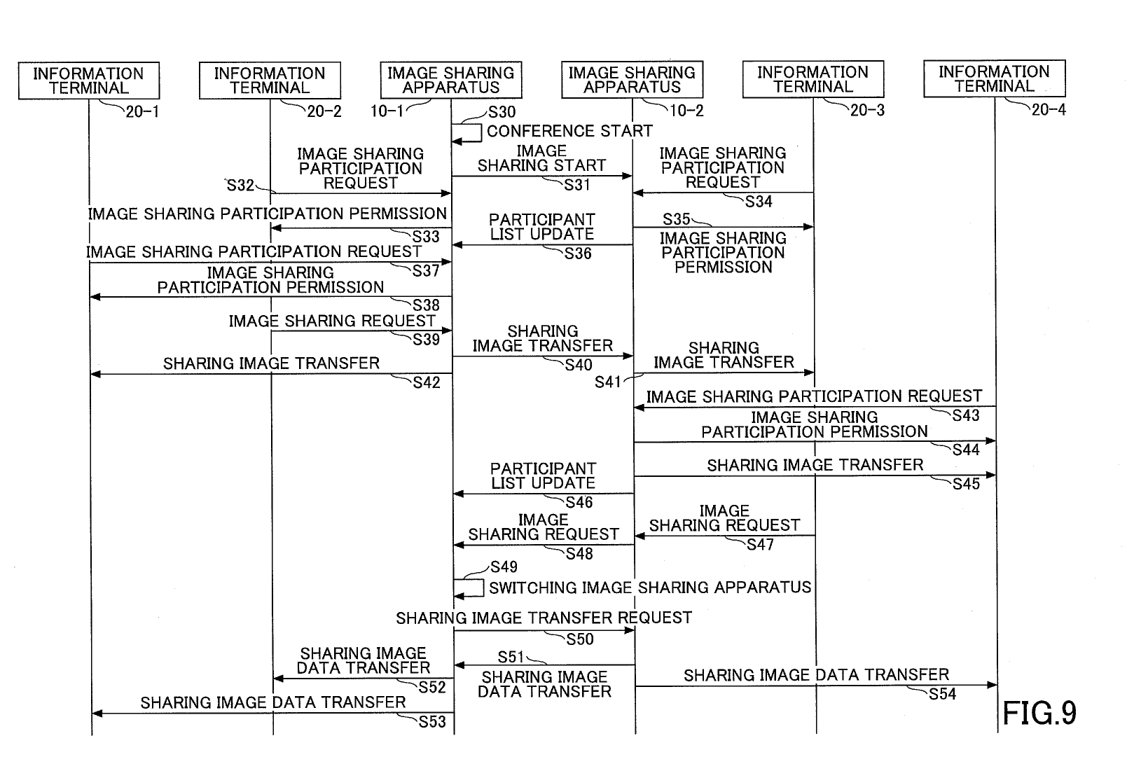

FIG. 9 is a sequence diagram illustrating an example of an image sharing process by another image sharing apparatus. The sequence shown in FIG. 9 is performed by the image sharing apparatuses 10-1 and 10-2, and the information terminals 20-1 through 20-4. It should be noted that processes S30 through S46 shown in FIG. 9 are the same as processes S10 through S26 shown in FIG. 4, and thus, the detailed description will be omitted.

As shown in FIG. 9, when a request for image sharing is received from the information terminal 20-3 participating in the conference (S47), the other image sharing apparatus 10-2 participating in the conference transmits the request for image sharing to the image sharing apparatus 10-1 used as a conference owner (S48).

Here, when the image sharing apparatus 10-1 determines that the sharing image should be switched (switched to the image sharing apparatus 10-2) according to the request of image sharing received in process S48 (S49), the image sharing apparatus 10-1 requests the image sharing apparatus 10-2 to transfer sharing image data (S50).

The image sharing apparatus 10-2 transfers the sharing image data received from the information terminal 20-3 to the image sharing apparatus 10-1 (S51). The image sharing apparatus 10-1 transfers the sharing image data to the information terminal 20-2 which has been registered in and controlled by the image sharing apparatus 10-1 itself (S52) and transfers the sharing image data to the information terminal 20-1 (S53). Further, the image sharing apparatuses 10-2 transfers the sharing image data to the information terminal 20-4 registered in and controlled by the image sharing apparatus 10-2 itself (S54).

It should be noted that in the case where the image sharing apparatus 10 other than the image sharing apparatus 10-2 (e.g., image sharing apparatus 10-3) is participating in the conference, it is possible for the image sharing apparatus 10-1 used as a conference owner to request the image sharing apparatus 10-2 to transfer the sharing image data to the image sharing apparatus 10-3. With the above arrangement, it is possible to decrease load of the image sharing apparatus 10-1 used as a conference owner.

As described above, in the case where another image sharing apparatus 10 receives a request for image sharing from an information terminal 20, the sharing image data are transferred to the information terminal 20 from the image sharing apparatus 10 in which the information terminal 20 is registered. With the above arrangement, it is possible to distribute the effort of the image sharing apparatus 10 used as a conference owner, and to hold a conference efficiently.

<Switching Image Sharing Screen>

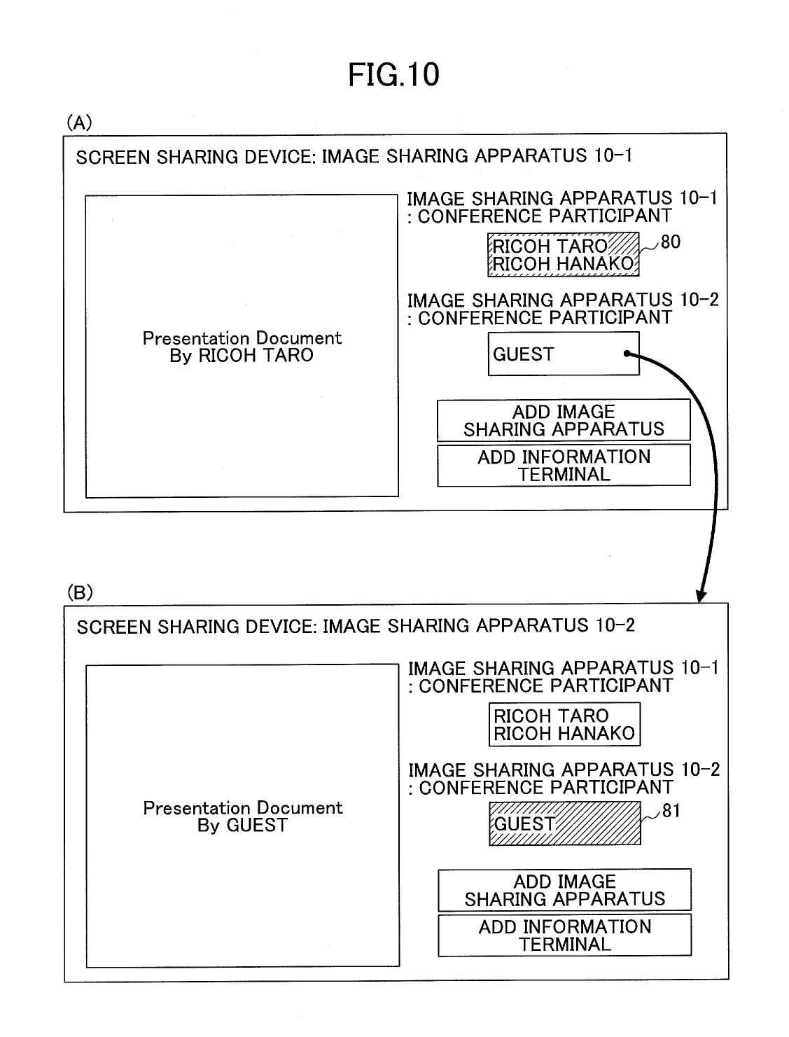

FIG. 10 is a drawing illustrating an example of switching an image sharing screen. In a screen (A) of FIG. 10 of the conference owner, sharing image data from an information terminal 20, from which a request for image sharing has been received, corresponding to a conference participant 80 of the image sharing apparatus 10-1 are shown.

Here, if the image sharing apparatus 10-1 used as a conference owner determines that the sharing image should be switched according to a request for image sharing received via the other image sharing apparatus 10-2, then the image sharing apparatus 10-1 selects a conference participant 81 of the other image sharing apparatus 10-2 (information terminal 20 controlled by the image sharing apparatus 10-2) as shown in a screen (B) of FIG. 10. With the above operation, it is possible to switch the screen in which an apparatus name of the image sharing apparatus 10 (whose data are currently displayed), the sharing image data, etc., are shown.

It should be noted that, in the case where the image sharing apparatus 10-1 used as a conference owner receives a request for image sharing from multiple image sharing apparatuses 10, the image sharing apparatus 10-1 may display multiple sharing image data at the same time.

According to the embodiment, it is possible to efficiently improve security. For example, it is possible for an image sharing apparatus used as a conference owner to hold a conference by providing permission for participating in the conference to another image sharing apparatus requesting for participation in the conference. It is possible for each of the image sharing apparatuses including the image sharing apparatus used as a conference owner to specify by itself information terminals to become a conference participant, and thus, it is possible to appropriately control conference participants. Further, it is possible to hold a conference with a remote location.

The present invention is not limited to the above specifically described embodiments, and various variations and modifications can be made without departing from the scope of the claims.

What is claimed is:

1. An image sharing apparatus comprising:
a first management unit configured to provide participation permission to one or more other image sharing apparatuses connected to the image sharing apparatus via a first network, and control the image sharing apparatuses to which the participation permission has been provided;
a second management unit configured to, when a participation request is received from one or more information terminals connected the image sharing apparatus via a second network, different from the first network, provide the participation permission to the information terminals, and control the information terminals to which the participation permission has been provided; and
a transfer unit configured to transfer image data to the other image sharing apparatuses controlled by the first management unit and the information terminals controlled by the second management unit.

2. The image sharing apparatus according to claim 1, wherein
the second management unit is further configured to, when the participation permission is provided by the other image sharing apparatuses in response to the participation request from the information terminals connected to the image sharing apparatus via the first network and the second network, obtain information related to the information terminal to which the participation permission has been provided.

3. The image sharing apparatus according to claim 2, wherein
the transfer unit is further configured to, when a sharing request of image data is received from the information terminal via the other image sharing apparatuses, transfer the image data, the sharing request of which has been received, to the information terminals in the second network to which the participation permission has been provided.

4. The image sharing apparatus according to claim 1, the image sharing apparatus further comprising:
a screen generation unit configured to switch and display one or more image data obtained via the information terminals to which the participation permission has been provided or the other image sharing apparatuses.

5. An image sharing system comprising a plurality of image sharing apparatuses connected to each other, wherein
a first image sharing apparatus of the image sharing apparatuses that has received a sharing start instruction from a user includes
a first management unit configured to provide participation permission to a second image sharing apparatus of the image sharing apparatuses and control the second image sharing apparatus to which the participation permission has been provided,
a second management unit configured to, when a participation request is received from one or more information terminals connected the first image sharing apparatus via a second network, different from the first network, provide the participation permission to the information terminals, and control the information terminals to which the participation permission has been provided, and
a transfer unit configured to transfer image data to the second image sharing apparatus controlled by the first management unit and the information terminals controlled by the second management unit.

6. A graphical user interface used in an image sharing system comprising a plurality of image sharing apparatuses connected to each other via a first network, the graphical user interface including
a screen generation unit configured to generate and display a screen in which at least one of first sharing image data obtained from a first image sharing apparatus of the image sharing apparatuses to which participation permission has been provided or a first information terminal of information terminals controlled by the first image sharing apparatus; first information related to the image sharing apparatuses; and second information related to the information terminals is shown, wherein
the screen generation unit switches the first sharing image data with second sharing image data obtained from a second information terminal selected from the second information, related to the information terminals shown in the screen.
